(19) United States
(12) Patent Application Publication
(10) Pub. No.: US 2017/0106340 A1
(43) Pub. Date: Apr. 20, 2017

(54) DESALINATION APPARATUS FOR SEAWATER USING PRESSURE-ASSISTED FORWARD OSMOSIS AND REVERSE OSMOSIS

(71) Applicant: GWANGJU INSTITUTE OF SCIENCE AND TECHNOLOGY, Gwangju (KR)

(72) Inventors: In Soo KIM, Gwangju (KR); Seung ho KOOK, Gwangju (KR); Do-seon HAN, Gwangju (KR); Sung Jo KIM, Gwangju (KR); Moon Hyun HWANG, Gwangju (KR)

(21) Appl. No.: 15/294,839

(22) Filed: Oct. 17, 2016

(30) Foreign Application Priority Data
Oct. 16, 2015 (KR) 10-2015-0144445

(51) Int. Cl. B01D 61/58; B01D 61/00; B01D 61/02; C02F 1/44

(52) U.S. Cl. CPC B01D 61/58; C02F 1/441; C02F 1/445; B01D 61/002; B01D 61/025; C02F 2103/08

(57) ABSTRACT

Disclosed herein is a seawater desalination apparatus using pressure-assisted forward osmosis and reverse osmosis. The seawater desalination apparatus includes: a forward osmosis unit receiving seawater and sewage; and a reverse osmosis unit receiving diluted seawater from the forward osmosis unit, wherein the forward osmosis unit comprises a first train arrangement and a second train arrangement, and the number of trains disposed in the first train arrangement is different from the number of trains disposed in the second train arrangement.

### BACKGROUND

1. Technical Field

The present invention relates to a seawater desalination apparatus using forward osmosis and reverse osmosis. More particularly, the present invention relates to a seawater desalination apparatus using pressure-assisted forward osmosis and reverse osmosis which can provide improvement in process efficiency and reduction in process costs through an efficient arrangement of trains used in a forward osmosis process.

2. Description of the Related Art

Water shortage becomes a severe problem all over the world due to global warming, climate change, environmental pollution, and the like. Since the vast majority of water on the earth is seawater, seawater desalination technology is becoming increasingly important as a means for solving water shortage problems.

Seawater desalination methods are mainly classified into an evaporation method and a reverse osmosis method. Since the evaporation method requires higher energy consumption than other desalination methods, the reverse osmosis method is most widely employed.

The reverse osmosis method is a method of desalinating seawater by applying pressure to a semipermeable membrane and has a problem of increase in energy consumption resulting therefrom. Thus, the reverse osmosis method is more costly than typical methods for producing drinking water.

In order to reduce energy consumption of the reverse osmosis method, research on employing a forward osmosis process as pretreatment for a reverse osmosis process is being conducted.

In such a method, reuse of water and dilution of seawater are possible, thereby providing reduction in energy costs.

However, this method has a problem in that a train used in forward osmosis has a low yield rate and a large number of trains are thus needed. Particularly, since such a train is expensive and bulky, it is important to efficiently arrange the trains.

Therefore, there is a need for an arrangement of trains which can improve a yield rate of each train and minimize the number of trains used in a forward osmosis process.

### BRIEF SUMMARY

The present invention relates to a seawater desalination apparatus using forward osmosis and reverse osmosis. It is one aspect of the present invention to provide a seawater desalination apparatus which can minimize the number of trains disposed in a forward osmosis unit, thereby reducing process costs.

It is another aspect of the present invention to provide a seawater desalination apparatus which can reduce pressure supplied to a reverse osmosis unit, thereby reducing process costs.

It is a further aspect of the present invention to provide a seawater desalination apparatus which can increase a yield rate of each train, thereby improving process efficiency.

In accordance with one aspect of the present invention, a seawater desalination apparatus using pressure-assisted forward osmosis and reverse osmosis includes: a forward osmosis unit receiving seawater and sewage; and a reverse osmosis unit receiving diluted seawater from the forward osmosis unit, wherein the forward osmosis unit includes a first train arrangement and a second train arrangement, and the number of trains disposed in the first train arrangement is different from the number of trains disposed in the second train arrangement.

According to embodiments of the present invention, it is possible to provide a seawater desalination apparatus using forward osmosis and reverse osmosis, which includes a forward osmosis unit and a reverse osmosis unit. The forward osmosis unit receiving seawater and sewage includes a first train arrangement and a second train arrangement, and the seawater and sewage may pass through the second train arrangement of the forward osmosis unit after passing through the first train arrangement of the forward osmosis unit. Here, the first train arrangement may include a larger number of trains than the second train arrangement. In other words, the number of trains constituting the second train arrangement is smaller than the number of trains constituting the first train arrangement, whereby the number of trains can be minimized, thereby reducing process costs.

In addition, the flow rate of sewage and seawater supplied from the first train arrangement to each train of the second train arrangement is greater than the flow rate of sewage and seawater supplied to each train of the first train arrangement, whereby the second train arrangement can have higher pressure than the first train arrangement. As a result, a reduced amount of pressure can be applied to the reverse osmosis unit, thereby reducing process costs.

### BRIEF DESCRIPTION OF THE DRAWINGS

The above and other aspects, features, and advantages of the present invention will become apparent from the detailed description of the following embodiments in conjunction with the accompanying drawings, in which;

FIG. 1 is a flow diagram of a process performed by a seawater desalination apparatus using forward osmosis and reverse osmosis which includes a forward osmosis unit and a reverse osmosis unit;

FIG. 2 is a schematic view of an arrangement of a first train arrangement and a second train arrangement disposed in a typical forward osmosis unit; and

FIG. 3 is a schematic view of an arrangement of a first train arrangement and a second train disposed in the forward osmosis unit according to the present invention.

### DETAILED DESCRIPTION

Hereinafter, exemplary embodiments of the present invention will be described in detail with reference to the accompanying drawings. However, it should be understood that the present invention is not limited to the following embodiments. In addition, descriptions of details apparent to those skilled in the art will be omitted for clarity.

A reverse osmosis desalination process consumes a large amount of electric energy, causing increase in process costs. In order to solve this problem, research on employing a forward osmosis process as pretreatment for a reverse osmosis process is being conducted.

However, since a train used in a forward osmosis process has a low yield rate, a large number of trains are required. In addition, such a train is expensive, causing low process efficiency and high process costs.

The present invention relates to a seawater desalination apparatus using forward osmosis and reverse osmosis.

More particularly, the present invention relates to a seawater desalination apparatus using forward osmosis and reverse osmosis, which can minimize the number of trains disposed in a forward osmosis unit and increase a yield rate of each train.

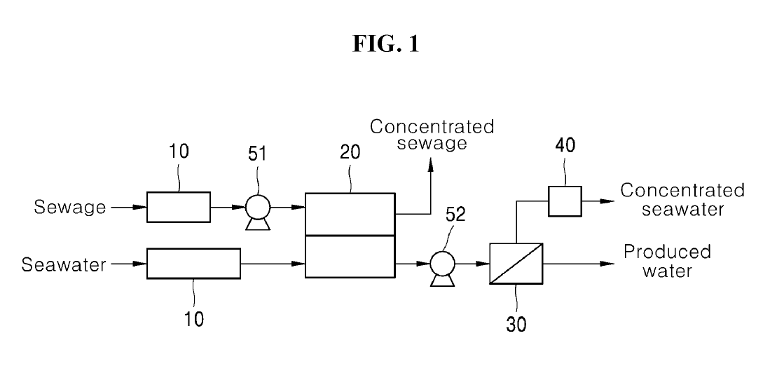

Referring to FIG. 1, a desalination apparatus for producing water from seawater and sewage includes: a pretreatment unit 10 performing pretreatment; a forward osmosis unit 20 performing a forward osmosis process; and a reverse osmosis unit 30 performing a reverse osmosis process.

In the seawater desalination apparatus using forward osmosis and reverse osmosis according to the present invention, seawater and sewage may be supplied to the forward osmosis unit after the seawater and sewage are subjected to pretreatment in the pretreatment unit.

Here, pretreatment in the pretreatment unit may be conducted using various membranes. For example, pollutants such as organic matter may be primarily removed using the membranes. Thus, it is possible to increase lifespan of membranes used in the forward osmosis unit and the reverse osmosis unit. For example, it is possible to reduce fouling of the membranes. Alternatively, a compound may be introduced during pretreatment to precipitate pollutants or to perform sterilization.

The sewage leaving the pretreatment unit 10 may be delivered to the forward osmosis unit 20 by a first booster pump 51. The first booster pump 51 may improve flowability of the sewage. Here, the pressure of the first booster pump 51 may range from about 1 bar to about 20 bar. For example, the pressure of the first booster pump 51 may range from about 5 bar to about 15 bar.

The seawater leaving the pretreatment unit 10 may be delivered to the forward osmosis unit 20.

In the forward osmosis unit 20, the seawater may be diluted and the sewage may be concentrated through forward osmosis. In the forward osmosis unit 20, the sewage may have a lower concentration than the seawater. In other words, the sewage may have relatively low concentration, and the seawater may have relatively high concentration. Thus, the pretreated sewage partially flows to the seawater through a forward osmosis membrane due to an osmotic pressure difference caused by concentration difference between the seawater and the sewage in the forward osmosis unit 20, such that the seawater can be diluted.

The diluted seawater may be delivered to the reverse osmosis unit 30 by a second booster pump 52. The second booster pump 52 can provide a pressure required for reverse osmosis. Here, the pressure of the second booster pump 52 may range from about 30 bar to about 50 bar. For example, the pressure of the second booster pump 52 may range from about 35 bar to about 45 bar.

The reverse osmosis unit 30 may discharge produced water through reverse osmosis and the concentrated seawater discharged without passing through a reverse osmosis membrane may be delivered to an energy recovery unit 40, which recovers energy from the concentrated seawater to use the energy to apply pressure to sewage and/or seawater.

Next, the forward osmosis unit 20 will be described in detail.

The forward osmosis unit 20 may include a first train arrangement 21 and a second train arrangement 22.

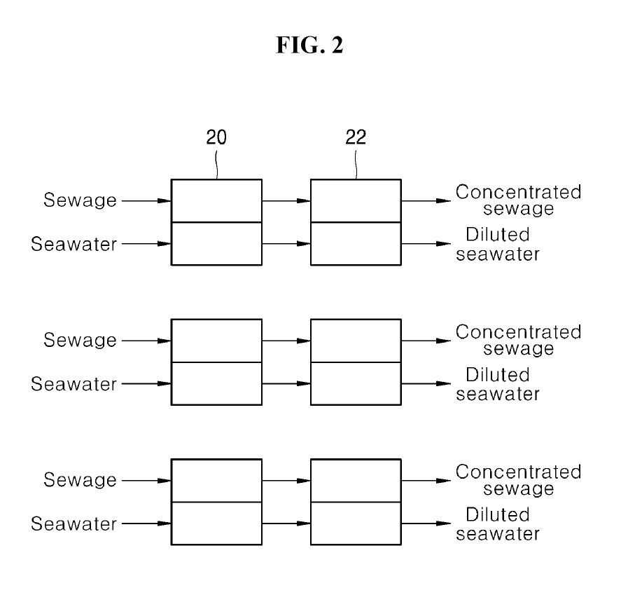

Referring to FIG. 2, in a typical two-pass treatment system, the first train arrangement 21 and the second train arrangement 22 are connected in series. In other words, the number of trains disposed in the first train arrangement 21 corresponds to the number of trains disposed in the second train arrangement 22. Thus, the forward osmosis unit 20 requires a large number of trains, causing increase in process costs. In addition, there is a problem of reduction in yield rate of each train.

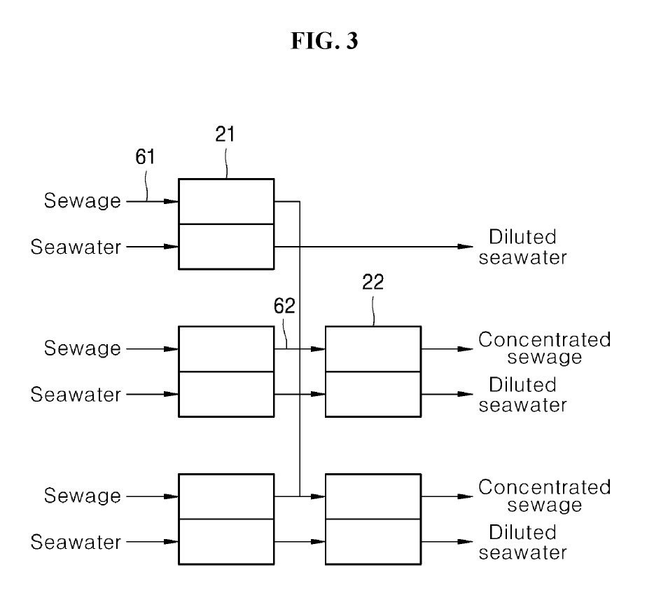

Referring to FIG. 3, in the forward osmosis unit 20 according to the present invention, the number of trains in the first train arrangement 21 may be different from the number of trains in the second train arrangement 22.

For example, each of the first train arrangement 21 and the second train arrangement 22 may include a plurality of trains. For example, the first train arrangement 21 may include a larger number of trains than the second train arrangement 22.

In other words, it is possible to reduce process costs by reducing the number of trains used in the second train arrangement 22.

For example, the number of first connection lines 61 supplying sewage and seawater to the first train arrangement 21 may be greater than the number of second connection lines 62 through which the sewage and seawater discharged from the first train arrangement 21 are supplied to the second train arrangement 22. More specifically, since the number of trains used in the second train arrangement 22 is reduced, the number of the second connection lines 62 may be reduced.

Thus, the second connection lines 62 may undergo a bottleneck. As a result, the residence time of the sewage and seawater in the first train arrangement 21 can be increased, and the total sectional flow area of the second train arrangement 22 becomes smaller than that of the second train arrangement 21, whereby the internal pressure of a flow path through which the sewage flows can be increased, thereby improving permeate flux in the first train arrangement 21 and a yield rate of each train. For example, the first train arrangement 21 may have a yield rate of 10% to 20%.

Further, since the number of the second connection lines 62 is smaller than the number of the first connection lines 61 and the number of trains constituting the second train arrangement 21 is smaller than the number of trains constituting the first train arrangement 22, the pressure of the second train arrangement 22 may be higher than the pressure of the first train arrangement 21.

Thus, in the forward osmosis unit 20, due to pressure increase caused by a bottleneck, permeate flux in the second train arrangement 22 can be improved and a yield rate of each train can be increased without using a separate pressure-supply device. For example, the second train arrangement 22 may have a yield rate of 8% to 16%.

Therefore, according to the present invention, it is possible to reduce the number of trains disposed in the forward osmosis unit 20 through efficient arrangement of existing trains. In addition, it is possible to improve a yield rate of each train disposed in the forward osmosis unit 20.

Although the present invention has been described with reference to some embodiments, it should be understood that the foregoing embodiments are provided for illustration only and are not to be construed in any way as limiting the present invention, and that various modifications, changes, alterations, and equivalent embodiments can be made by those skilled in the art without departing from the spirit and scope of the invention. For example, each component described in the embodiments of the present invention can be modified in various forms. In addition, differences relating to these modifications and applications are to be construed as within the scope of the invention defined in the appended claims. Therefore, the scope of the invention should be limited only by the accompanying claims and equivalents thereof

What is claimed is:

1. A seawater desalination apparatus using pressure-assisted forward osmosis and reverse osmosis, comprising:
a forward osmosis unit receiving seawater and sewage; and
a reverse osmosis unit receiving diluted seawater from the forward osmosis unit,
wherein the forward osmosis unit comprises a first train arrangement and a second train arrangement, and the number of trains disposed in the first train arrangement is different from the number of trains disposed in the second train arrangement.

2. The seawater desalination apparatus according to claim 1, wherein each of the first train arrangement and the second train arrangement comprises a plurality of trains and the first train arrangement comprises a larger number of trains than the second train arrangement.

3. The seawater desalination apparatus according to claim 1, wherein the second train arrangement has a higher pressure than the first train arrangement.

4. The seawater desalination apparatus according to claim 1, wherein seawater and sewage are delivered to the first train arrangement through first connection lines,
sewage and seawater discharged from the first train arrangement are delivered to the second train arrangement through second connection lines, and
the number of second connection lines is smaller than the number of first connection lines.
